(19) United States
(12) Patent Application Publication
(10) Pub. No.: US 2010/0308125 A1
(43) Pub. Date: Dec. 9, 2010

(54) Liquid Spray Dispenser

(75) Inventors: John Depiano, Burlington, MA (US); Deirdre McKeown, Winchester, MA (US)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: Reckitt Benckiser Inc., Parsippany, NJ (US)

(21) Appl. No.: 12/675,199

(22) PCT Filed: Aug. 26, 2008
(86) PCT No.: PCT/GB2008/002867

§ 371 Date: May 17, 2010

(30) Foreign Application Priority Data
Sep. 4, 2007 (GB) 0717104.4

(51) Int. Cl. B05B 1/08

(52) U.S. Cl. 239/4; 239/102.1

(57) ABSTRACT

The present invention provides a compressible spray dispensing container which includes a quantity of a liquid treatment composition contained therein, and a dispensing means which dispensing means includes a fluidic oscillator which provides for oscillation of the liquid exiting the dispensing means, and particularly via a nozzle.

The present invention relates to a liquid spray which is particularly suited to dispense a fluid, preferably a liquid from a container, preferably a pressurizable container to an ambient environment, which is adapted to apply the fluid in a spray type pattern to a surface present in the environment. Desirably, the application of the liquid is in a spray-type pattern in order to provide a swath or area of coverage.

The application of a fluid, preferably a liquid from a container is notoriously old in the art. Many consumer products are provided as a package or a container which includes a vessel, flask, bottle, canister, or other three-dimensional device which is used to contain a quantity of a treatment composition, such as a liquid, wherein the package or container also incorporates as a part they are of a dispensing it means. Such a dispensing means may is typically provided in order to permit a consumer to dispense a measured quantity of the treatment composition when desired or necessary. Widely used dispensing means include closures which are little more than a cap which is used to seal the contents of a package or a container, such as a bottle containing a quantity of a treatment composition in the form of a liquid. Further widely used dispensing means include combination closures which also include one or more elements which provide for the metered dispensing of and the delivery of the contents of the container to the ambient environment, such as to a surface, airspace, et cetera. Such combination closures include for example; manually operable trigger spray devices which include a closure which is used to sealingly attach a trigger spray device to a container such as a bottle, and wherein the user manually operates and pumps the trigger spray device in order to dispense a fluid, typically a liquid; an pressurized canister or container, which contains a quantity of both a treatment composition, as well as a propellant which is used to pressurized the contents of the canister or container, and to also provide a motive force for expelling the treatment composition via a nozzle to an ambient environment, as well as a “toggle-cap” which is a closure which provides both a sealing function as well as a dispensing function via a movable elements which provides for a conduit or passage through which the treatment composition within the container may be expelled and provide it to an ambient environment.

From a consumer perspective, dispensing of a liquid in the form of a spray is particularly desirable when a surface is to be treated. Dispensing a liquid in the form of a spray usually provides for generally uniform coverage of a surface on which the composition is applied, as such an application typically results in a thin film of the composition on a surface which is formed by the spray droplets impinging upon and coating a part of the surface. Typically, even a thin film of the treatment composition is effective in order to provide a desired benefit, such as a cleaning and or disinfecting benefits, and thus providing such a composition using a spray-type dispenser is advantageous. However, the two most common types of spray dispensers which are currently widely used are pressurized canisters or trigger-spray type dispensers. With regard to the former, pressurized canisters are frequently preferred as they provide for a fine dispersion of droplets exiting the container which in turn, form a generally uniform and a thin film of the treatment composition impinging a surface. However, such pressurized canisters also have undesirable features in that typically containers are required to be of metals which over long-term storage periods may corrode and leak and, additionally, such containers also require a propellant gas which may be an inner gas such as carbon dioxide, or an environmentally unfriendly halocarbon gas. With regard to the latter, trigger-spray type dispensers also suffer a number of undesirable features, including the relative complexity of the trigger spray pump which frequently requires a number of moving parts, and such moving parts require close-tolerance fit in order to ensure the reliable operability of the pump, and additionally the dispensing of the composition frequently requires a plurality of pumping cycles in order to prime the pump, and to continue dispensing the liquid composition to an ambient environment and particularly to a surface.

Thus, while the prior art provides a variety of containers which are useful in dispensing illiquid composition to an ambient environment, there is nonetheless a real and continuing need in the art for further improvements to such containers.

It is to these and other objects that the current invention and is presently directed.

In a first aspect, the present invention provides a compressible spray dispensing container which includes a quantity of a liquid treatment composition contained therein, and a dispensing means which dispensing means includes a fluidic oscillator which provides for oscillation of the liquid exiting the dispensing means, and particularly via a nozzle.

In a second aspect of the invention, the present invention provides a compressible spray dispensing container which includes a non-pressurized, but pressurizable container such as a collapsible flask or bottle, which container includes a quantity of a liquid treatment composition contained therein, and a dispensing means which dispensing means includes a fluidic oscillator which provides for oscillation of the liquid exiting the dispensing means, and particularly via a nozzle.

In a third aspect, the present invention provides a compressible spray dispensing container which includes a quantity of a liquid treatment composition contained therein, a fluid flow control means, and a dispensing means which dispensing means which includes a fluidic oscillator which provides for oscillation of the liquid exiting the dispensing means, and particularly via a nozzle.

In a fourth aspect, the present invention provides a compressible spray dispensing container which includes a quantity of a liquid treatment composition contained therein, a fluid flow control means, and a dispensing means which dispensing means includes a fluidic oscillator which provides for oscillation of the liquid exiting the dispensing means, and particularly via a nozzle, wherein the pressurizablecontainer can be used to dispense the liquid composition when the pressurizablecontainer is in an upright orientation, or in an inverted orientation.

In a fifth aspect of the present invention there is provided a method for dispensing any liquid treatment composition from a compressible spray dispensing container utilizing the pressurizablecontainer according to any of the foregoing aspects of the present invention, or utilizing any of the specific embodiments of the invention is described herein.

It is believed that the present invention will be better understood from the following description of preferred embodiments, taken in conjunction with the accompanying drawings, in which like reference numerals identify identical or corresponding elements.

The accompanying figures disclose certain particularly preferred embodiments of the present invention.

FIG. 1 discloses and a cross-section view a first embodiment of a compressible spray dispensing container 10 which includes a quantity of a liquid treatment composition 40 contained therein, and a dispensing means 20 which dispensing means includes a fluidic oscillator 50 which provides for oscillation of the liquid exiting the dispensing means. The compressible container 10 comprises a flask or bottle 11 (hereinafter referred to uniformly as a “bottle”) which includes at least one of sidewall 16 which depends upwardly from a base 12 and a top portion 17 which depends from the sidewall and which includes a neck 13. The neck 13 defines a passage 18 into the interior 19 the bottle 11. The neck 13 includes an end 14 and desirably includes a coupling means 15, here shown as a circumferential recess extending into the interior of the neck 13 and below the end 14 of thereof. This provides a liquid seal-type engagement with the neck 13 and in particular with the coupling means 15 as is visible on the dispensing means 20. Herein, the dispensing means 20 is in the form of a closure or such and as a generally cylindrical closure which incorporates a corresponding coupling means 22, here a correspondingly shaped circular recess which is dimensioned in order to engage and provide a snap-type fit, or alternately may be a interference-type fit between the coupling means 15 of the neck 13 with the dispensing means 20. Further visible from the figure is the fluidic oscillator 50 which is integrated into the construction of the dispensing means 20. The fluidic oscillator 50 includes a top surface 51 and an exit orifice (not visible) from which emanates the liquid passing through the fluidic oscillator 50 from the interior of the container 10, and further includes an inlet 52, here in the form of a hollow tube or which extends downwardly through the dispensing means 20 and extends into the interior of the compressible container 10 in the region of the neck 13. As can be seen from that figure, depending from the inlet 52 is a flexible dip tube 60, having a proximal end 62 in a liquid-tight interference fit with the inlet 52, and having a distal end 64 which extends downwardly in the interior of the bottle 11 wherein the distal end of 64 terminates at an open and adjacent to or proximal to the base 12. As can be seen from the figure, the entire length of the flexible dip tube 60 defines a fluid channel adapted for the transport of a fluid, particularly a liquid such as the liquid 40 present within the bottle 11.

With regard out of the bottle 10, it is to be understood that bottle is formed of a compressible material which can be temporarily deformed such as may occur when did the sidewall 11 of the bottle 10 is compressed, and ideally manually squeezed by a consumer one who holds the container 10 by its sidewall 11. Such an operation causes pressurization of the interior 19 on the bottle 11, thereby forcing the liquid 40 present within the bottle through the open distal and 64 of the dip tube 60, and thereafter through the fluidic oscillator 50 and subsequently into the ambient environment. Ideally, the consumer positions the container 10 such that the liquid treatment composition 40 is directed onto a surface, which is intended to be treated by the liquid composition 40. Preferably, the container 10 is formed of a material such that the reduction of pressure, such as the release of pressure on the sidewall 11 by the consumer allows for the container tend to return to its original, uncompressed shaped which also causes the cessation of liquid composition 40 being forced through the dip tube 60 and through the fluidic oscillator 50. Such an operation provides for the convenient dispensing of the liquid treatment composition 40 in a spray-type pattern without requiring either a trigger-spray type pump apparatus, or a pressurized canister such as an aerosol canister. Surprisingly, the use of the fluidic oscillator 50 provides for a well distributed pattern of liquid droplets being expelled from the fluidic oscillator 50 such that a swath of liquid droplets is dispensed upon a hard surface.

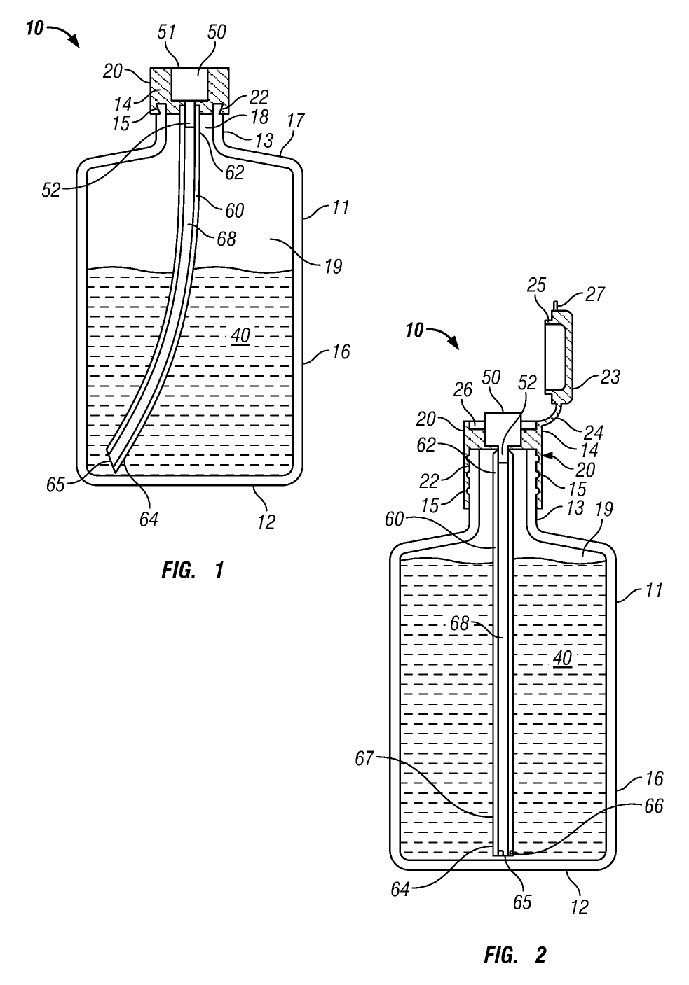

Turning now to FIG. 2 therein is depicted in a cross-sectional view a further example of compressible spray dispensing container according to the invention. As can be seen thereon, the compressible spray dispensing container 10 includes a bottle 11 containing a quantity of a liquid treatment composition 40 contained therein, a neck 13 having as coupling means 15 a plurality of threads which extend outward leave from the neck 13 below with the end 14 of the neck 13, a dispensing means 20 in the form of a closure which includes a fluidic oscillator 50 as an element thereof, which dispensing means 20 further includes a movable cover 23 which depends via an intermediate hinge element 24. The movable cover 23 can be moved with respect to the remaining part of the dispensing means 20 such that a circular sidewall 25 may be inserted to an interior upper cavity 26 of the dispensing means 20 and thereby form any liquid-tight relation seal therewith. To facilitate such an operation, and a small tab 27 extends outwardly from a portion of the cover 23, which tab 27 improves the grasp ability of the cover 23 and its removal and separation from the remaining part of the dispensing means to quantity. The provision of such an arrangement and configuration of the dispensing means provides for a convenient method to seal the fluidic oscillator 50 and two isolated from the ambient environment between dispensing operations. Such also provides for means to control any possible leakage of the liquid treatment composition 40 which may occur if the bottle 11 is inadvertently inverted. The dispensing means 20 also further includes as corresponding coupling means 20 to a series of threads which are configured and adapted to engage in the plurality of threads which are the coupling means 15 of the bottle 11, and by such engagement provide any liquid-tight seal between the bottle 11 and the dispensing means 20. Further, as is clearly visible from the figure there is further provided in a dip tube 60 which however in this embodiment is to be understood as a rigid, generally inflexible dip tube which has a proximal end 62 in an interference-type, liquid-tight fit with the inlet 52 of the fluidic oscillator 50, and a distal end 64 which extends downwardly into the interior 19 of the bottle and terminates at an open and 65. In this embodiment of the dip tube 60, adjacent to the periphery of the open end 65 is a series of passages 66 which extends through the sidewall 67 of the dip tube 60. This series of passages 66 is provided to ensure continued flow of the liquid treatment composition 40 into the interior of the dip tube 60, even if the base 12 of the bottle 11 is deformed such that it contacts the distal and 64 of the dip tube 60. Such may foreseeably occur if a consumer grasps the bottom portion of the sidewall 16 of the bottle 11 and compresses the sidewall 11 inwardly which may cause the base 12 to flex upwardly, that is to say in the direction of the neck 13.

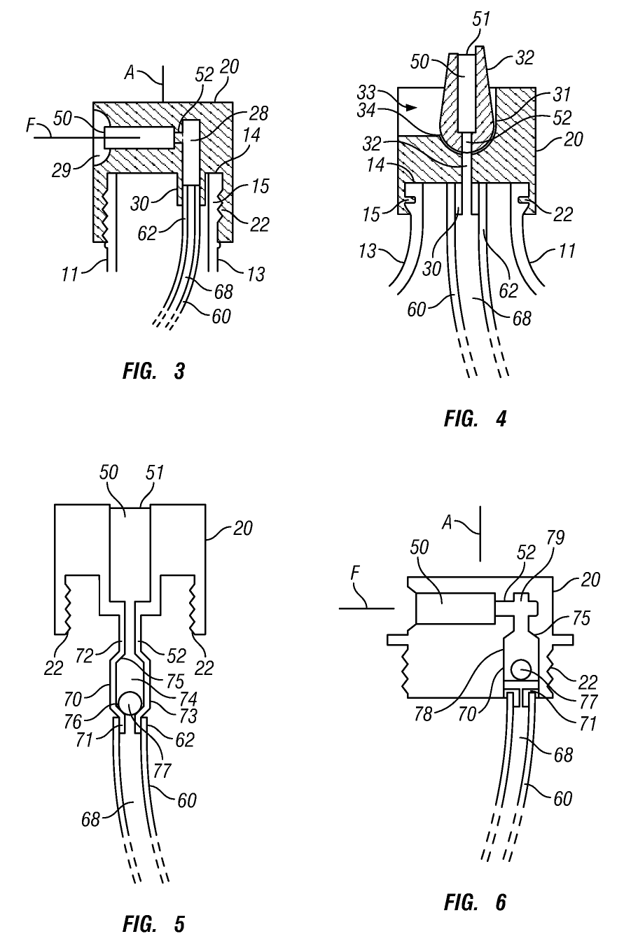

With regard at the FIG. 3 there is depicted a cross-sectional view of a dispensing means 20, and a portion of a bottle 11 upon which the dispensing means 20 is mounted. For the sake of clarity, most of the bottle 11 has been omitted from the figure but is to be understood that the bottle 11 may be that according to any of the other configurations of bottles 11 described in this specification and/or may be any other suitable configuration. As is seen thereon, dispensing means 20 is mounted in a liquid-tight sealing relationship with the bottle 11 via the corresponding engagement of the coupling means 15, here a series of threads extending outwardly from the neck 13 with the coupling means 22 of the dispensing means 20, here a correspondingly dimensioned set of threads, and the end 14 of the neck 13 of the bottle 11 which is compressed against a part of the dispensing means 20. As is further visible, the dispensing means 20 includes a cylindrical connector 30 which extends around the exterior of the proximal end 62 of the dip tube 60 and forms a liquid-tight seal therewith, and an interior cavity 28, here in the form of a cylindrical bore which is in fluid communication with the interior passage 68 of the dip tube 60. As is visible from the drawing, the direction of the cylindrical bore is essentially parallel to central axis “A” of the dispensing means 20, while the fluidic oscillator 50 which has a central axis “F” as defined by the inlet 52 and the exit orifice (not visible) of the fluidic oscillator 50, is positioned such that the central axis “A” and the central axis “F” are approximately perpendicular with respect to one another. This configuration and placement of the fluidic oscillator 50 within the dispensing means 20 provides for a re-direction of the direction of the liquid treatment composition such that and as at the liquid treatment composition 40 passes through the dip tube 60, it enters the interior cavity 28, and then changes its flow direction by approximately 90° as it passes through the fluidic oscillator 50 from which it is expelled via the exit orifice into the ambient environment. A peripheral recess 29 adjacent to the periphery of the end 51 of the fluidic oscillator 50, such as a dish shaped recess as depicted on FIG. 3 may also be provided. Such a configuration of the dispensing means 20 as depicted on FIG. 3 provides for a convenient arrangement of elements whereby a consumer is provided with a compressible spray dispensing container 10 and may grasp the bottle 11 and keep it in a vertical orientation, but have of the contents of the bottle 11 dispensed and a side-wise manner in a direction generally perpendicular to the central axis of the bottle 11 (not shown). Such a configuration may be particularly convenient for use wherein the liquid treatment composition is intended to treat vertical or inclined to surfaces, particularly walls, mirrors, tiled surfaces, the sloping walls of a toilet, and the like.

With regard at the figure for, there is depicted a further embodiment of a closure means 20 mounted upon a part of a bottle 11, wherein in the present embodiments the closure and means includes a fluid directing toggle element. Again, for the sake of clarity a major portion of the depiction of the bottle 11 has been omitted in this view but any bottle fulfilling the requirements described in this specification can be used. As is seen thereon, the bottle 11 includes a neck 13, the neck having an end 14 and coupling means 15, here in the form of a circumferential recess extending inwardly within the neck 13 proximate to but below the end 14 thereof. The coupling means 15 forms a liquid tight seal with a corresponding circular element 22 which is formed as part of the closure means 20 whereby said coupling means is an element which forms a snap-type fit with the coupling means 15. Such an arrangement of coupling means 15, 22 provides a means for an effective liquid-tight seal which is difficult to be disengaged by a consumer. The closure means further includes a cylindrical connector 30 which engages the proximal end 62 of the dip tube 60 and forms a liquid tight seal there with. Extending through the cylindrical connector 30 is a fluid passage 32 which extends through the closure means 20 wherein it terminates in a semi-circular cavity 31. Contained within part of the semicircular cavity 31 is a toggle element 32 containing therein a fluidic oscillator 50, the end 51 thereof which may be directed outwardly into the ambient, and at the opposite end an inlet 52 which comprises a fluid passage which, when the toggle is in its fully open to position such as it is visible in FIG. 4, forms a continuous fluid passage with the fluid passage 32 and in turn with the interior 68 of the dip tube 60, through which said continuous fluid passage the liquid treatment composition may course. While not shown in the figure, it is understood that the toggle element 32 pivots such that it may be rotated whereby it is positioned to be substantially within the toggle cavity 33. In such a configuration, the toggle element 32 rotates and desirably a part of the toggle base 34 forms a liquid tight closure with the fluid passage 32 of the closure means, and thereby denying the passage of the liquid treatment composition from the closure means 20 via the fluidic oscillator 50. Such an arrangement of elements of the closure means is particularly convenient from a consumer standpoint.

Turning out a FIG. 5 there is depicted any further aspect of the present invention, namely a closure means 20, and a fluid flow control means 70. It is to be understood that for the sake of clarity and discussing this embodiment, the bottle 11 has been omitted from the figure but it is to be understood that a bottle 11 forms a further feature of the embodiment discussed with reference to the present figure. As is seen in this cross-sectional view, and the closure means 20 includes as an element of air of a fluidic oscillator 50 having an end directed outwardly from the closure means, and at the opposite ends an inlet 52 which is in fluid communication with the fluid control means 70. The fluid control means 70 includes a fluid inlet 71, a fluid outlet 72, and an intermediate fluid control body 73. In the present embodiment, the fluid control body 73 is provided by a hollow chamber 74 having a fluid inlet seat 76, a fluid outlet seat 75, and intermediate therebetween a ball 77 which is freely movable between the said fluid inlet seat 76 and the fluid outlet seat 75. Further, as depicted the proximal end 62 of the dip tube 60 is in a liquid-tight type connection with the fluid inlet 71. It is to be understood that in the current embodiment, the orientation of the closure means 20 is it vertical such that any compression of the bottle 11 (not shown) forces the liquid treatment composition (not shown) upwardly through the interior 68 of the dip tube 60, which forces the ball 77 to rise partially above the fluid inlet seat 76 but not sufficiently that it forms a seal against the fluid outlet seat 75 which would deny the further passage of the liquid treatment composition upwardly through the fluidic oscillator 50 and outwardly from the closure means. Rather, the fluid control means 70 functions primarily as a check valve to deny the undesired escape of the liquid treatment composition when the closure means 20 is in an inverted orientation in which circumstance, the ball 77 comes to rest against the fluid outlet 75 and forms a liquid-tight seal therewith and as denying the passage of the liquid treatment composition through the fluidic oscillator 50. Such is particularly desirable in providing an effective control against undesired leakage of the contents of the compressible spray dispensing container 10 due to accidental inversion.

With regard to FIG. 6, there is provided in alternate arrangement of a closure means 20 incorporating a fluid control means 70. As can be seen, the relationship between the fluidic oscillator 50 and the closure means 20 is similar to that as depicted in FIG. 3, namely in that the direction of the axis F of the fluidic oscillator and hence the direction of the spray discharge that they are from is approximately perpendicular to the center axis A of the closure means 20. Again, as has been described with regard to FIG. 5, for the sake of clarity in the bottle 11 has been omitted from the figure although it is to be understood that the bottle forms a feature of the embodiment according to FIGS. 6 and albeit not shown. As can be further seen from an examination of the figure, the fluid control means 70 is an integral part of the closure means 20 and is comprised of a fluid cavity 78 having a fluid outlet seat 75, and a fluid inlet 71 which forms a liquid tight connection with the dip tube 60 such that the interior 68 of the dip tube is 60 is in fluid communication with the fluid cavity 78. Further forming part of the fluid control means 70 is a loose ball 77 which is dimensions such that if it contacts the fluid outlet seat 75 it is intended to form a liquid tight seal therewith. Upstream of the fluid outlet seat 75 is a fluid conduit 79 which is in fluid communication with the inlet 52 of the fluidic oscillator 50. While not depicted in particular detail in FIG. 6, it is nonetheless to be understood that one or more fluid passages are included within the fluid inlet 71 whereby the liquid treatment composition coursing through the interior 68 of the dip tube 60 may pass upwardly into the fluid cavity and about the exterior of the loose ball 77 and thereon continue its course into the fluid conduit, and thereafter pass through the fluidic oscillator 50 from which it is expelled to the ambient. The dimensions of the ball 77 as well as its mass should be selected such that it does not unduly or undesirably block the flow of the liquid treatment composition through the closure means while the bottle 11 is compressed but rather, primarily functions only when the compressible spray dispensing container 10 is accidentally inverted so to limit the amount of inadvertent or undesired leakage.

With respect now to FIG. 7, there is depicted a still further embodiment of a closure means 20 incorporating a fluid control means 70. Yet again, as has been discussed with regard to FIGS. 5 and 6, for the purposes of clarity the bottle 11 has been omitted from the figure but it is to be understood that any bottle forms and a feature of the depicted embodiment. As a shown, the closure means 20 includes a fluidic oscillator 50 having in and 51, and an inlet 52 were in the axis F of the fluidic oscillator 50 is approximately coincidence, or coincident with the central axis A the closure means. As is further visible from the figure, the inlet 52 is in fluid communication with the fluid control means 70. In the instant embodiment, the fluid control means 70 includes a fluid cavity 78 which here is approximately bisected by a flexible valve 80. The fluid control means 70 also includes a fluid inlet 71 in fluid communication with the dip tube 60 such that any treatment composition passing through the interior 68 of the dip tube 60 and tenors of the fluid cavity 78, and many pass across the flexible valve 80 and through a fluid outlet 72 which is in fluid communication with the inlet 52 of the fluidic oscillator 50. The flexible valve 80 maybe any element which may open and close responsive to the pressure differential across the fluid cavity 78 and desirably, when the pressure between at the fluid inlet 71 is at least 1 psi, preferably at least 1.5 psi, more preferably at least 2 psi greater than at the fluid outlet 72 or of the ambient pressure, the flexible valve 80 opens to allow for the passage of the liquid treatment composition across the fluid cavity 78 and into and ultimately out of the fluidic oscillator 50. Advantageously, the flexible valve 80 is form of a resilient material, preferably elastomeric material such as in a natural rubber, a synthetic rubber or elastomeric polymer materials such as but not limited to silicone, polyisoprene, and the like. An advantageous feature on the fluid control means 70 as depicted in the figure is that it does not require a specific placement of a loose ball within the fluid control means 70 in order to control the flow, but rather is primarily operated by the pressure differential across the fluid control means 70.

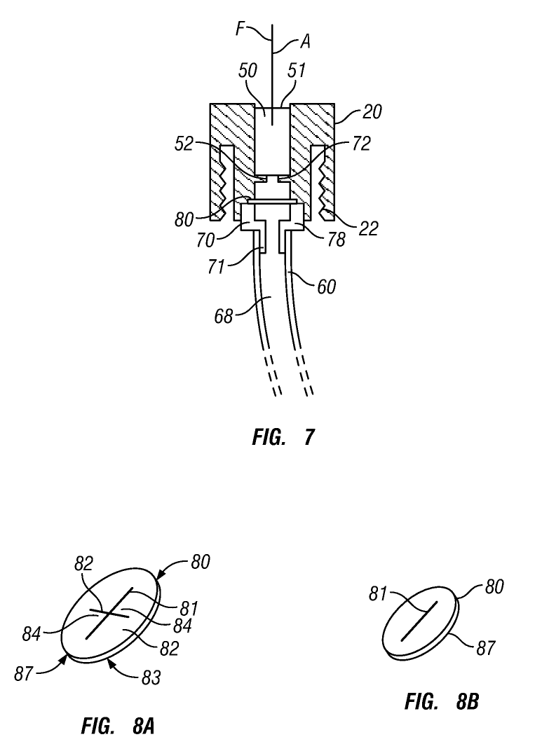

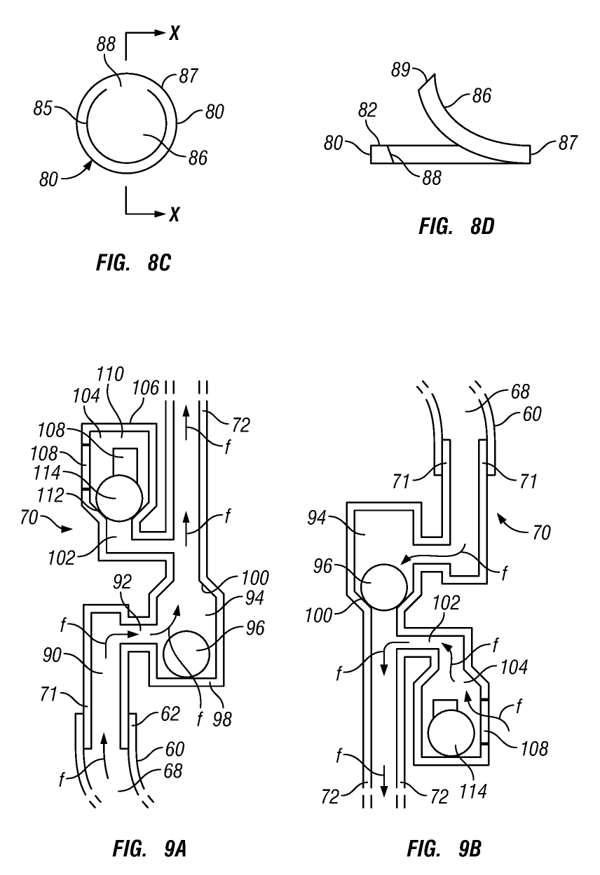

Turning now to FIGS. 8A, 8B, 8C and 8D there are depicted several embodiments of a flexible valve 80 which is been described with reference to FIG. 7. As can be seen from all of the embodiments, advantageously the flexible valve 80 is generally circular in configuration, and has a thickness dimension or at a height which is preferably not more than ⅓, more preferably not more than ¼ and yet more preferably not more than ⅕ of its diameter. With regard now to FIG. 8A, the flexible valve 80 includes two crossed slits 81, 82 which intersect at the center of the flexible valve 80, and while passing through the height of the flexible valve 80 do not extend to the periphery 87 thereof. It is to be understood that in the presence of a pressure differential across opposite faces of the flexible valve 80, namely the top face 82 and the bottom face 83 thereof, the flap portions 84 formed at the regions of the crossed slits 81, 82 or flexible and extend upwardly and outwardly from the top face 82. However, when the pressure differential ceases, the elastomeric nature of the flexible valve 80 permits for in the portions of the flexible valve 82 return to its prior generally planar configuration. FIG. 8B depicts an alternate embodiment of the flexible valve 80, were in a single slit 81 passes through the valve but does not extend to the per referee there of. Such a valve structure and might be useful wherein the thickness or the height of the flexible valve 80 intended to be particularly thin. Under a pressure differential, it is expected that the flexible valve 80 may contort or bulge, thereby permitting for the slit 81 to open and permit for the passage of the liquid treatment composition through the slit and thereby across the valve 80. Again, with the removal of the pressure differential, it is expected that the elastomeric nature of the valve 80 permits for it to return to its prior, generally planar configuration as illustrated in the figure. FIGS. 8C and 8D depict a still further embodiment of a flexible valve 80 and two views, the former being a top plan view, and the latter being a side view along the axis “x-x”. As can be seen from FIG. 8C, the valve 80 includes an arcuate slit 85 which is proximate to the periphery of the valve and 80. Advantageously, the radius of the arcuate slit 85 is at least 90°, preferably at least 180°, more preferably at least 270°, or even greater as is depicted in the figure. The provision of an arcuate slit 85 having a particularly large radius defines a valve flap 86 which is movable with respect to the periphery 87 and at the same time also defines a hinge region 88 wherein the periphery 87 and the valve flap 86 are connected. With respect now to the cross-sectional view provided in FIG. 8D, the interrelationship between the valve flap 86 and the remaining elements of the valve 80 or more clearly understood. In this figure, the valve flap 86 is in an open position whereby the valve flap 86 is distorted and bends upwardly and outwardly from the top face 82 of the valve 80. In such a configuration, the liquid treatment composition is permitted to pass across the valve 80. As is further visible from the figure, the arcuate slit is tapered with respect to the periphery 87 such that's there is formed a sloping face 88 adjacent to the periphery 87, and a corresponding sloping face 89 at the faces of the valve flap 86. It is to be understood that when the pressure differential across the valve 80 ceases, the elastomeric nature of the valve 80 permits for the valve flap 86 to resume a generally planar configuration and for the sloping face 89 to abut the sloping face 88 adjacent to the periphery and thereby forming a liquid tight seal therebetween.

While the fluid control means discussed to thus far in this specification may be effective in limiting the amount of, or denying the leakage of liquid treatment composition from the compressible spray dispensing container 10 if such is inadvertently inverted, a shortcoming of such is that such also limits the amount of inclination of the compressible spray dispensing container 10, and usually also denies for the dispensing of the liquid treatment composition when it is intended to hold the compressible spray dispensing container 10 and an inverted position. Such may occur for example, when it is intended to spray the contents of the compressible spray dispensing container 10 downwardly. While the embodiments of FIGS. 3 and 6 provide useful configurations for a side-directional dispensing of the liquid treatment composition, such not be wholly satisfactory if the compressible spray dispensing container 10 is inclined such the direction of the flow of the dispensing liquid treatment composition is below the horizontal, and particularly when it is less than about 60°, and even more not more than about 45° with respect to the horizontal. The horizontal is easily established by the level of the surface of the liquid treatment composition contained within the bottle of the compressible spray dispensing container 10.

They shortcoming may be overcome by using a fluid control means 70 which permits for the partial or total inversion of the compressible spray dispensing container 10 and which still provides for effective delivery of the liquid treatment composition. Examples of suitable fluid control means which fulfill this function are generally known to the art, and include, inter alia, those described in one or more of the following: EP 0968767, U.S. Pat. No. 5,979,712 to Montaner, EP 1593788 B1 to Ferey, JP 11019549 A to Takayuki, U.S. Pat. No. 4,277,001 to Nozawa, U.S. Pat. No. 6,126,042 to Meshberg, U.S. Pat. No. 6,186,372 to Garcia as well as U.S. Pat. No. 7,055,722 to Ouellette, the contents of each of the foregoing which is expressly incorporated by reference in their entirety herein.

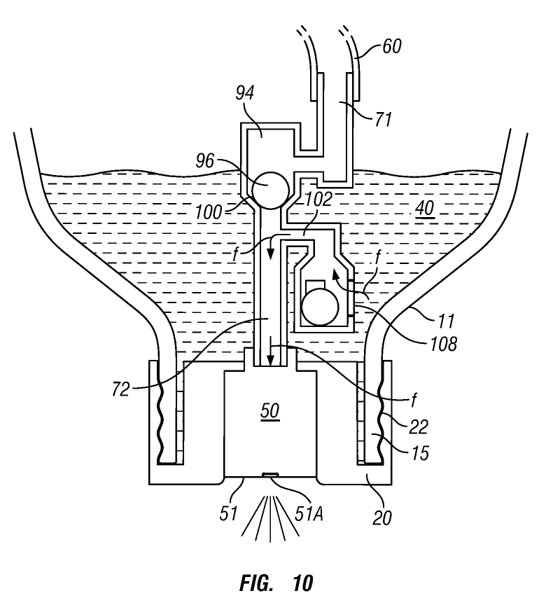

One preferred embodiment of a fluid control means 70 which permits for the partial or total inversion of the compressible spray dispensing container 10 and which still provides for effective delivery of the liquid treatment composition is depicted on FIGS. 9A, 9B and 10.

With reference to FIG. 9A, the fluid control means 70 and it is understood that the fluid control means 70 is depicted in an upright configuration, that is say, wherein the fluid control means 70 is oriented vertically and upwardly from the horizontal. As is visible from that figure, the proximal and 62 of the dip tubes 60 is in a sealed tight relationship with the fluid inlet 71 or by fluid communication is established between the interior 68 of the dip tubes 60, and an inlet conduit 90. The inlet conduit 90 extends upwardly, and includes an outlet 92 and fluid communication with a first fluid chamber 94 which contains a freely movable ball 96. As visible from the figure, the direction of the outlet 92 is transverse to the general and/or central axis of the inlet conduit 90, and is essentially parallel to the general and/or central axis of the first fluid chamber 94. Furthermore, the first fluid chamber 94 includes a base 98 upon which the ball 96 rests on the fluid control means 70 is in an upright configuration as shown. Upwardly from the base 98, which is coincidentally also upstream with reference to the direction of fluid flow and opposite to the base 98 is a first fluid chamber seat 100, beyond which further extends a fluid outlet 72 which is in fluid communication with the first fluid chamber 94. While not visible in the figure, it is to be understood that the fluid outlet 72 is ultimately in fluid communication with a fluidic oscillator 50 which is further downstream of the fluid control means 70. Intermediate the first fluid chamber 94 and the fluid outlet 72 and in fluid communication therewith is a branch fluid conduit 102 which in turn is in fluid communication with a second fluid chamber 104 the second fluid chamber 104 includes a base 106 and one or more passages 108 passing through a sidewall 110 of the second fluid chamber 104. Additionally, opposite the base 106 the second fluid chamber 104 includes a second fluid chamber seat 112, against which a second freely movable ball 114 contained within the second fluid chamber 104 rests and forms a liquid tight seal therewith when the fluid control means 70 is in an upright configuration as shown. As will be understood with reference to FIG. 9A, when the bottle (not shown) containing a liquid treatment composition (not shown) is compressed, the direction of the flow of said liquid treatment composition is as depicted by directional arrows “f” word and it is seen that upward flow of the liquid treatment composition is unhindered by the first ball ball 96, but is hindered by the second ball 114 and thereby is not permitted to escape outwardly through the passages 108 but is forced through the fluid outlet 72 where it is to be understood that it thereafter passes through the fluidic oscillator 50 and thence is sprayed into the ambient.

FIG. 9B illustrates the fluid control means 70 in an inverted position, more specifically inverted 180° with respect to the depiction of FIG. 9A, as is visible from the figure, the passage of any of the liquid treatment composition which may be present in the first fluid chamber 94 is blocked from further downstream passage by the seal formed between the first ball 96 and the first fluid chamber seat 100. Any of the liquid treatment composition which is present in the region surrounding the second fluid chamber 104 passes through one or more of the passages 108, and into the interior of the branch fluid conduit 102 and thence downstream through the fluid outlet 72 where it is to be understood that it thereafter passes through the fluidic oscillator and is thus sprayed into the ambient. As can be seen from a comparison of FIG. 9A and 9B, in each case of orientation one but not both of the balls 96, 114 functions as a check valve depending upon the relative orientation of the fluid control means 70.

The operation of the fluid control means 70 as depicted on FIG. 9B and wherein the compressible spray dispensing container 10 is in an inverted position with respect to the horizontal is disclosed in more detail in FIG. 10. As depicted thereon, the flow of any of the liquid treatment composition which may be present in the first fluid chamber 94 is blocked from further downstream passage by the seal formed between the first ball 96 and the first fluid chamber seat 100, while simultaneously the liquid treatment composition which is present in the bottle 11 surrounding the second fluid chamber 104 passes through one or more of the passages 108, and into the interior of the branch fluid conduit 102 and thence downstream through the fluid outlet 72 where it thereafter passes through the fluidic oscillator 50 and is thus sprayed via the as is visible from the figure, the passage of any of the liquid treatment composition which may be present in the first fluid chamber 94 is blocked from further downstream passage by the seal formed between the first ball 96 and the first fluid chamber seat 100. Any of the liquid treatment composition which is present in the region surrounding the second fluid chamber 104 passes through one or more of the passages 108, and into the interior of the branch fluid conduit 102 and thence downstream through the fluid outlet 72 where it is to be understood that it thereafter passes through the fluidic oscillator and is thus sprayed out via the exit orifice 51A and into the ambient. As is visible from the figure, the fluid control means 70 provides for an effective method for the near total evacuation of the liquid treatment composition 40 which may be provided to a consumer in a compressible spray dispensing container 10.

While the fluid control means 70 depicted in FIGS. 9A, 9B and 10 provide one useful and preferred embodiment of an invertible fluid control means 70, it is to be understood that alternate elements and devices not particularly disclosed herein, but which nonetheless provide for a useful in invertible fluid control means may be incorporated in conjunction with, or in place of the preferred embodiments described herein.

As discussed above, an essential element of the compressible spray dispensing container 10 is a fluidic oscillator.

The fluid spray means is a fluidic oscillator which, in contrast to conventional fluid spray nozzles which are directed to primarily provide a stream of fluid, preferably a liquid exiting the nozzle, or which alternately provide a spray which is caused by one or more elements forward of the liquid exiting the nozzle which causes the said liquid to disperse when exiting the nozzle but without oscillation of the liquid, the fluidic oscillator can be distinguished in that as the liquid exits the nozzle, the construction of the fluidic oscillator causes the oscillation of the liquid of the liquid exiting the nozzle, which oscillating liquid may impart a spray type pattern or a fan type pattern, or for that matter a different pattern. Preferably the fluidic oscillator in one which provides for the cyclical change of the fluid directions as fluid exits from the fluidic oscillator. Many fluidic oscillators which may be used as the fluid spray means are per se, known in the art. By way of non-limiting example such include those described in U.S. Pat. No. 3,185,166 to Horton, U.S. Pat. No. 3,563,462 and U.S. Pat. No. 4,157,161 to Bauer, U.S. Pat. No. 4,463,904 to Bray, U.S. Pat. No. 4,052,002, US RE 33158, U.S. Pat. No. 4,508,267, U.S. Pat. No. 4,151,955, U.S. Pat. No. 5,035,361, U.S. Pat. No. 5,213,269, and U.S. Pat. No. 5,971,301 to Stouffer, U.S. Pat. No. 5,213,270 and U.S. Pat. No. 6,186,409 to Srinath, U.S. Pat. No. 6,253,782 to Raghu, U.S. 711800 to Berning, as well as those described in published patent applications US 2007-0063076 A1 to Gopalan, and US 2006-0065765 A1 to Hester the contents of which are herein incorporated in their entirety by reference.

A preferred embodiment of a fluidic oscillator is one wherein the design of the fluidic oscillator provides for the internal instability of two jets of liquid in a cavity, wherein the two jets are properly sized and oriented in an interaction chamber such that the resulting flow pattern give a system of vortices which are inherently unstable and cause the two jets to cyclically change their directions. This provides a sweeping jet at the exit of the chamber, hence oscillation of the fluid exiting the nozzle. Preferably the exit outlet or aperture can be designed to produce either an oscillating sheet for area coverage or a fan type, planar spray. The power nozzles need not be symmetrically oriented relative to the central axis of the oscillation chamber. Moreover, the outlet and outlet throat can be adapted to issue a yawed sweeping jet.

A further preferred embodiment of a fluidic oscillator useful in the present invention is one which operates on a pressurized liquid flowing through the fluidic oscillator to generate a jet of liquid that flows from said insert and into the surrounding gaseous environment to form a spray of liquid droplets, wherein the fluidic oscillator includes: (a) a member having top, front and rear outer surfaces, (b) a fluidic circuit located within this top surface and having an inlet, an outlet and a channel whose floor and sidewalls connect the inlet and outlet, and a barrier located proximate the outlet that rises from the channel floor and is configured such that: (i) it divides the channel in the region of the barrier into what are herein denoted as two power nozzles, and (ii) each of these nozzles has a downstream portion that is configured so as to cause the liquid flowing from the nozzles to generate flow vortices behind the barrier that are swept out of the outlet in such a manner as to control the lateral rate of spread of liquid droplets from the fluidic oscillator.

A still further preferred embodiment of a fluidic oscillator useful in the present invention is one which includes a liquid delivering orifice and includes a member having a front and a rear surface and a passage that extends between these surfaces, wherein a portion of this passage is configured in the form of a fluidic circuit, and the configuration of this fluidic circuit is chosen so as to provide a desired oscillating spray pattern. Preferably an upstream portion of the passage may include an expansion section portion which has an orifice that connects this expansion section with the surrounding environment so as to allow a liquid flowing through this passage to entrain the gaseous environment surrounding the member into the passage. When the liquid is a soap-like solution, desirably a foam is generated that can effectively be sprayed by the fluidic oscillator.

The compressible spray dispensing container 10, and the individual elements thereof may be formed of any suitable material. Advantageously naturally occurring or synthetic polymers provide excellent materials of construction as they are readily molded or otherwise formed into appropriate shapes and configurations. Additionally such polymers are often resistant to the treatment compositions, and particularly with respect to the bottle are resilient and flexible, and thus provide for compressible flasks or bottles. Such are known to the art and include, e.g., any of a number of thermosettable or thermoformable synthetic polymers such as are widely used in casting or injection molding. Exemplary synthetic polymers such as polyamides, polyolefins (e.g., polypropylene, polyethylene) as well as polyalkyleneterephalates (i.e., polyethylene terephthalate, polybutylene terephthalate), polystyrenes, polysulfones, polycarbonates as well as copolymers formed from monomers of one or more of the foregoing being several nonlimiting examples of useful synthetic polymers

The compressible spray dispensing containers of the invention provide a particularly effective device for the effective storage and spray delivery of liquid treatment compositions which provide a good distribution of droplets into the ambient, and preferably onto a surface needing treatment by the composition without the need for pressurizing a container with a propellant or without needing a manually operable trigger spray pump or a push-spray pump.

The compressible spray dispensing containers of the invention provide several technical advantages. In preferred embodiments the spray dispensing container require a very low operating pressure, with internal pressures as minimal as 0.5 psi (pounds per square inch) being sufficient, although improved spray delivery and increased rates of product delivery are attained at higher pressures. Improved spray delivery is readily achieved by controlling the pressure on the compressible container; under higher pressure a wider spray pattern is often achieved, while under lower pressures a narrower spray pattern is often achieved. Additionally, in preferred embodiments there is no recoil effect, such as may be observed by a consumer utilizing a trigger spray type device or an aerosol canister. Further, in preferred embodiments the compressible spray dispensing containers of the invention may be sprayed in an upright position, in an inverted position, as well as in generally horizontal positional orientations. Still further in preferred embodiments, the compressible spray dispensing containers of the invention capable of near total evacuation of its liquid contents, and can be caused to empty with as little as 1 fluid ounce, preferably with is little as 0.5 fluid ounce and more preferably with as little as 0.25 fluid ounce of the liquid treatment composition contained therein remaining in the container.

While described in terms of the presently preferred embodiments, it is to be understood that the present disclosure is to be interpreted as by way of illustration, and not by way of limitation, and that various modifications and alterations apparent to one skilled in the art may be made without departing from the scope and spirit of the present invention.

1. A compressible spray dispensing container which includes a quantity of a liquid treatment composition contained therein, and a dispensing means which dispensing means includes a fluidic oscillator which provides for oscillation of the liquid exiting the dispensing means.

2. A compressible spray dispensing container according to claim 1 which includes a non-pressurized, but pressurizable container such as a collapsible flask or bottle, which container includes a quantity of a liquid treatment composition contained therein, and a dispensing means which dispensing means includes a fluidic oscillator which provides for oscillation of the liquid exiting the dispensing means.

3. A compressible spray dispensing container according to claim 1, which includes a quantity of a liquid treatment composition contained therein, a fluid flow control means, and a dispensing means which dispensing means which includes a fluidic oscillator which provides for oscillation of the liquid exiting the dispensing means.

4. A compressible spray dispensing container according to claim 1, which includes a quantity of a liquid treatment composition contained therein, a fluid flow control means, and a dispensing means which dispensing means includes a fluidic oscillator which provides for oscillation of the liquid exiting the dispensing means, and particularly via a nozzle, wherein the pressurizablecontainer can be used to dispense the liquid composition when the pressurizablecontainer is in an upright orientation, or in an inverted orientation.

5. (canceled)

6. A method for dispensing any liquid treatment composition from a compressible spray dispensing container utilizing the pressurizable container according to claim 1.
